(19) United States
(12) Patent Application Publication
(10) Pub. No.: US 2008/0296993 A1
(43) Pub. Date: Dec. 4, 2008

(54) ROTOR FOR AN ELECTRIC MOTOR

(75) Inventor: Niels Christian Weihrauch, Flensburg (DE)

Correspondence Address: MCCORMICK, PAULDING & HUBER LLP, CITY PLACE II, 185 ASYLUM STREET, HARTFORD, CT, 06103, US

(73) Assignee: DANFOSS COMPRESSORS GMBH, Flensburg (DE)

(21) Appl. No.: 12/138,679

(22) Filed: Jun. 13, 2008

(30) Foreign Application Priority Data
Jun. 14, 2006 (DK) PA 2007 00859

(51) Int. Cl. H02K 17/16; H02K 15/02

(52) U.S. Cl. 310/211; 29/598

(57) ABSTRACT

The invention provides a method of making a squirrel cage rotor for an electrical motor, and to a rotor for such a motor. The rotor comprises a rotor stack of a magnetically conductive material and a squirrel cage of an electrically conductive material. At least one of the short circuit rings are made by compression and sintering of a powder in which a solid element is embedded. The solid element facilitates manufacturing by increasing strength of potentially weak areas of the rotor, e.g. around openings into the shaft bore, rotor slots etc.

### CROSS REFERENCE TO RELATED APPLICATIONS

Applicant hereby claims foreign priority benefits under U.S.C. § 119 from Danish Patent Application No. PA 200 filed on Jun. 14, 2007, the contents of which are incorporated by reference herein.

### FIELD OF THE INVENTION

The present invention relates to a rotor and a method of making a rotor for an electrical motor and, more particularly, to a squirrel cage rotor.

### BACKGROUND OF THE INVENTION

In one type of commonly used electrical motors, a stator comprises a stator winding or several windings in which an electrical field creates a rotating magnetic field. Inside, or in case of an external rotor, circumferentially outside the stator, a rotor is rotationally attached to rotate under influence of the magnetic field. Various principles exist. In a synchronous motor, the rotor is magnetised, or comprises a set of permanent magnets. This type of motor is simple and reliable, and the rotational speed of the rotor corresponds to the rotational speed of the electrical field in the windings of the stator. In certain applications, however, the synchronous motor has an inappropriate start-up characteristic. In asynchronous motors, the rotor comprises substantially longitudinally extending windings which in axially opposite ends of the rotor are interconnected by short circuit rings. Typically, a rotor for an asynchronous motor comprises a rotor core made from a magnetically conductive material and a squirrel cage wherein the windings and short circuit rings are moulded in one piece from an electrically conductive material, e.g. aluminium. The rotor could be laminated from sheets of a metal, wherein each sheet comprises an opening which, in combination with other sheets, form conductor slots extending axially through the rotor. After the assembly of the sheets into a stack, conductive bars, constituting the windings are moulded directly into the conductor slots using the slots as a mould, and the short circuit rings are moulded as an integral part of the bars. In use, an electrical current is induced into the windings of the rotor by the magnetic field generated in the stator, and due to a shift between the electrical field in the windings of the stator and in the windings of the rotor, the rotor rotates relative to the stator.

Since the squirrel cage is moulded onto the rotor stack, relatively large dimensional changes takes place when the rotor cools down. Since the rotor stack and squirrel cage are made from different materials and with different geometries, the dimensional changes are unequal and therefore lead to tension and in worst case to deformation or cracking of the rotor. When making a rotor by sintering metal powder, cracking may in particular occur after compression of the powder and before the subsequent heating thereof.

### SUMMARY OF THE INVENTION

It is an object of an embodiment of the invention to provide an improved rotor for an electrical motor and to provide an improved method of making a rotor for an electrical motor.

In a first aspect, the invention provides a method of making a squirrel cage rotor for an electrical motor. The method comprises the steps of:
providing a mould for sintering,
providing in the mould a first portion of powder which is adapted for sintering,
providing a solid element in the mould,
providing a rotor stack with axially extending rotor slots in the mould,
filling the rotor slots with a second portion of powder,
filling an upper space above the rotor stack with a third portion of powder, and
sintering the powder.

The squirrel cage could be of any kind adapted for use in an asynchronous motor or for use in a line-start motor. Accordingly, the mould may be provided with a geometry whereby it can shape the powder to form two axially displaced short-circuit rings arranged on opposite sides of the rotor stack and axially, or helically, extending conductors extending through the rotor stack between the short circuit rings. Accordingly, the first portion of the powder may form at least a portion of a first one of the short-circuit rings, and the solid element may form another portion of that short-circuit ring. The axially extending rotor slots in the rotor stack constitutes cavities in which the second portion of powder is filled and thereby forms the conductors of the rotor. The third portion of powder forms at least a portion of the other short-circuit ring.

Sintering of the powder typically implies compression of the powder to a solid, however not very strong body of compressed particles. The particles are subsequently bonded more solidly by heating. In this process, the solid element strengthen the rotor, or specifically the part of the rotor which is made from compressed powder, and the solid element therefore provides easier handling of the rotor in particular until the heating of the body of compressed powder.

The powder could be of a kind generally used for sintering and having electrically conductive characteristics comparable to that of aluminium or alloys thereof. As an example, the powder could contain Al, Cu and other electrically conductive metals and combinations thereof.

The method may comprise compression of the powder at any time between the mentioned steps. As an example, the first portion could be provided in several smaller portions which are compressed separately. Correspondingly, the second portion could be provided in several smaller portions which are compressed separately. In this case, the compression can be performed by use of elongated rods which enter the rotor slots and compress the powder therein. Correspondingly, the third portion could be provided in a number of smaller portions which could be compressed separately. However, all steps of filling and compression, and optionally also sintering is advantageously performed in one single mould comprising a lower part forming a cavity for the powder, for the rotor stack and for the solid element, and an upper part which is movable relative to the lower part and which can enter into the cavity to compress the powder therein.

The first, second and third portions of powder could contain identical powder, or they could contain differently formulated powders. As an example, the powder of the second portion of powder could conduct electricity better than the powder in the first and third portions of powder, or the powder in the second portion could be adapted more specifically to enable compression and strength and thereby to facilitate the elongated and possibly slender shape of the rotor slots.

The rotor could be adapted to be carried in a stator for rotation around a centre axis. In the following, centre axis denotes the axis around which the rotor is adapted for rotation relative to the stator. For this purpose, the rotor comprises a shaft bore which extends axially through the rotor stack. A drive shaft is attachable in the shaft bore for carrying the rotor rotationally relative to the stator. The rotor stack is made from sheets of a magnetically conductive metal which is stacked to form a laminated core. Each sheet comprises openings which, in combination with openings in the other sheets, form the shaft bore and the axially extending slots. When the rotor stack is arranged in the mould, and the slots are filled with the second portion of the powder, conductive bars constituting the rotor windings are formed directly in the conductor slots using the slots as a mould. The first portion of powder may be compressed between a lower part of the mould and one axial end face of the rotor stack, and the third portion of powder is compressed between an opposite axial end face of the rotor stack and an upper part of the mould.

The mould may comprise a lower form part and an upper form part. At least one of the form parts may form a cavity in which the powder and the solid element are arranged. In one embodiment, the lower form part forms a cavity which is shaped to match the shape of the rotor stack, so that the lower form part seals against one of the two axial end faces to facilitate compression of the powder therein to form one axial short circuit ring directly between the end face and the lower form part. For this purpose, the cavity may be ring shaped and dimensioned to circumference the shaft bore. In a similar manner, the other form part may be shaped and dimensioned to match the opposite end face of the rotor stack.

The mould may preferably form a sidewall which extends around the rotor stack and thereby supports the rotor stack and prevents collapsing thereof during the compression of the powder on each side of the rotor stack. Correspondingly, the mould may comprise a core part which is dimensioned and arranged to extend into the shaft bore in the rotor stack and thereby supports that part of the rotor stack.

The mould may further comprise a number of press pins which are arranged and dimensioned to be pressed into the rotor slots for compression of the second portion of the powder. In order to facilitate filling of the slots with powder, the press pins may be movable out of the mould cavity to leave space for the powder. To facilitate repeated compression of the second portion of powder during filling of the rotor slots, the press pins may be relative to the lower or upper form part at different positions so that they extend a variable length into the cavity of the mould. The press pins could be partly helically shaped, and the mould may comprise a spindle feed or threaded means for conveying the press pins into the rotor slots during a rotational movement of the press pins around the centre axis.

The solid element is provided mainly to facilitate compression of the powder in the mould. When the powder is compressed between the mould parts and the axial end faces of the rotor stack, it may be difficult to obtain desired tolerances and strength of the body of compressed powder, especially at, or near the openings into the rotor slots and shaft bore.

To allow the rotor shaft to extend through the solid element, the solid element may be a ring shaped element forming an opening which can be aligned with the shaft bore in the rotor stack. In particular, the solid element may have a circular hole which is dimensioned equal to or smaller than the shaft bore. In this way, the solid element can separate the powder from the edge of the shaft bore and thereby prevent that the powder enters the shaft bore.

The solid element may be arranged directly against and in contact with one of the end faces of the rotor stack. The element could be kept in place by being partly embedding in a body of the compressed (and subsequently sintered) powder. The element could be in contact with a first area of the end face and the body may be in contact with, and adhered to a second area of the end face, from which area the body extends at least partly around the element and thereby fixates the element between the rotor stack and the body.

The solid element could be made from powder which is compressed into a solid shape, and optionally the powder could be sintered prior to the arrangement of the solid element in the mould. The solid element could also be made from compressed powder which is sintered simultaneously with the sintering of the other parts of the rotor. Alternatively, the solid element is an element provided by more traditional processes such as by cutting or stamping from a sheet metal or from a traditional moulding technique.

The mould may comprise a guiding pin which can be used for location of at least one of the rotor stack and the solid element. The guiding pin could have a first section with a first diameter and second section with a second diameter, where the first diameter fits into the shaft bore, and the second diameter fits into the circular hole of the solid element.

The powder could be sintered, i.e. heated to a temperature wherein the particles are joined by sintering, between any of the mentioned steps, e.g. when each of the first, second or third portion of the powder has been filled into the mould. Alternatively, the powder is sintered when all three portions have been filled into the mould. In one embodiment, the powder is compressed to form a coherent body which includes the compressed powder, the rotor stack and the solid element. The body is removed from the mould and heated to a temperature at which the compressed powder sinters.

In one embodiment of the invention, an additional solid element is arranged in the mould after the rotor stack has been arranged in the mould. The additional element can be ring shaped with a geometry which matches the shape of the rotor stack to prevent contact between the powder of the third portion of powder and an upper edge of the shaft bore and to prevent powder of the third portion of powder to enter into the shaft bore. In one embodiment, the additional element is solid, i.e. without a centre opening. This creates a rotor with a shaft bore which is closed in one end.

Any hole provided in any of the solid elements could be covered by penetratable closing means to further prevent powder from entering the shaft bore. As an example, the holes can be covered with a foil material which is easily ruptured when the shaft is attached in the shaft bore.

In a second aspect, the invention provides a squirrel cage rotor for an electrical motor, the rotor comprising a rotor stack of a generally magnetically conductive material and a squirrel cage of a generally electrically conductive material, the squirrel cage forming elongate conductors extending through the rotor stack and terminating in short circuit rings on axially opposite sides of the rotor stack, at least one of the short circuit rings comprising a first element which is located between the rotor stack and a second element, the second element being sintered onto at least one of the first element and the rotor stack.

By magnetically rotor stack and electrically conductive squirrel cage is meant that the rotor stack comprises an electrically conductive material and that the squirrel cage comprises an electrically conductive material. Non magnetically or electrically conductive materials may also be comprised in the rotor stack and squirrel cage, respectively. However, typically, a major portion is of an electrically or magnetically conductive material. The second element could be sintered onto an end face of the rotor stack and it may encapsulate enough of the first element to fixate the first element relative to the rotor stack. The second element may also be sintered both onto the first element and onto the end face of the rotor stack.

The conductors could extend in parallel to a centre axis around which the rotor is rotatable in an electrical motor.

The rotor stack may be dimensioned so that it can withstand pressure which is applied to the rotor during the sintering, and it may e.g. be made from high-alloy, e.g. an alloy which is not annealed or which is at least not completely annealed, e.g. an alloy containing silicon in a content above 0.5 percent, e.g. between 0.5 and 2 percent.

The second element may comprise a rim portion which peripherally encircles the first element and which is sintered onto the rotor stack and the first element may be at least partly embedded in the second element.

The first element may be ring shaped with a centre-opening allowing a shaft to extend through the element and into the rotor stack. The centre-opening may e.g. have a cross-sectional area being at most equal to a cross-sectional area of the shaft bore, and it may preferably be a circular centre-opening.

At least one of the first element and the second element could be made from a material which contains aluminium, and at least one of the first element and the second element could be made from a material which contains cobber. In one embodiment, the first and second elements are made from the same material.

The second element could be formed from a powder which is compressed and sintered. Likewise, the conductors could be formed from a powder which is compressed and sintered onto the first element.

To improve the bonding between the first element and the second element, the elements may be joined in an irregular interface zone, i.e. a zone which is non-straight, e.g. a stepped, jagged or indented zone which provides an increased area of the two elements compared to a straight and smooth interface.

The first element may be located directly against an end face of the rotor stack, and the second element may form an axial end face of the rotor.

The electrically conductive material could be isolated from the magnetically conductive material. This could be done e.g. by providing the first element from a material which is neither magnetically, nor electrically conductive. As an example, the first element could be made from a non-metal material, e.g. a plastic material. Likewise, the rotor stack may be coated to increase an iron-oxide layer on a surface thereof to isolate the electrically conductive material from the magnetically conductive material.

### BRIEF DESCRIPTION OF THE DRAWINGS

In the following, preferred embodiments of the invention will be described in further details with reference to the drawing in which:

FIG. 1 illustrates in a cross-sectional view, a rotor according to the invention,

FIG. 2 illustrates a perspective view of a squirrel cage for a rotor according to the invention,

FIG. 3 illustrates a rotor stack seen from above,

FIG. 4 illustrates an embodiment of the rotor with a ring shaped element,

FIGS. 5-8 illustrate different views and elements of a squirrel cage rotor,

FIGS. 9-11 illustrate a sequence of making a rotor,

FIGS. 12-14 illustrate a sequence of making one of the short-circuit rings,

FIG. 15 illustrates an irregular interface zone between the sintered body and the solid element, and

FIGS. 16-19 illustrate four different embodiments of the rotor according to the invention.

### DETAILED DESCRIPTION OF THE PREFERRED EMBODIMENTS

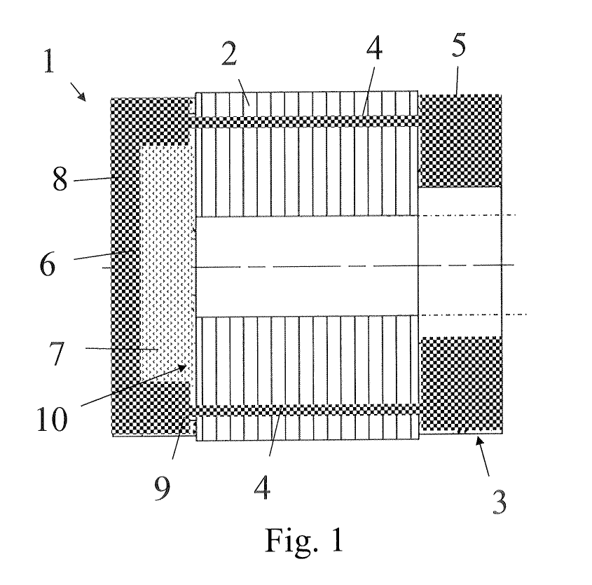

FIG. 1 illustrates a rotor according to the invention. The rotor 1 comprises a rotor stack 2 of a magnetically conductive material and a squirrel cage 3 of an electrically conductive material. The squirrel cage forms elongate conductors 4 which extend through the rotor stack 2 and terminate in short circuit rings 5, 6 on axially opposite sides of the rotor stack 2. One of the short circuit rings 5, 6 comprises a first element 7, and a second element 8. The first element 7 is located directly adjacent an end face 10 of the rotor stack 2 between the second element 8 and the rotor stack 2. The second element 8 comprises a peripheral portion 9 which surrounds the first element 7 and from which the elongate conductors extend into the rotor stack 2. The second element 8 thereby fixates the first element 7 to the rotor stack 2.

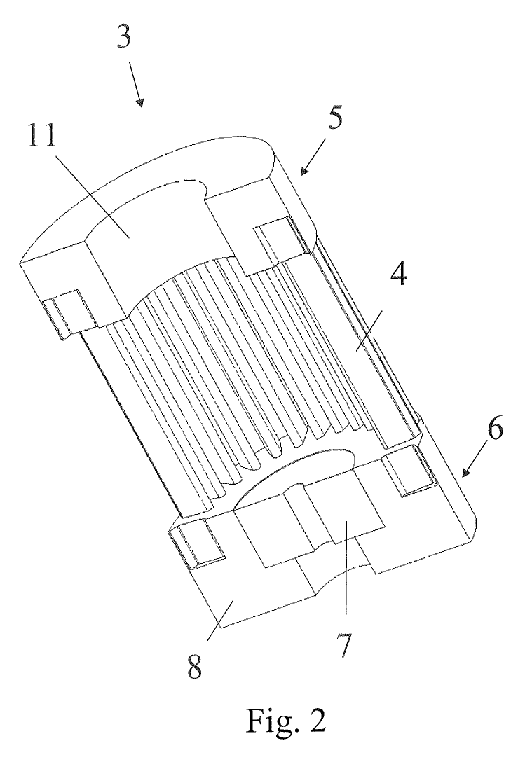

FIG. 2 illustrates the squirrel cage 3, i.e. the rotor without the rotor stack. In this view, it is more clearly seen that one of the short circuit rings 6 is constituted by two elements. The first element 7 is a solid element which is embedded in the second element 8. The second element 8 is made by sintering of powder which is compressed in a mould. The opposite short circuit ring 5 is made throughout from sintered powder which is compressed in the mould. The centre-bore 11 is provided for a drive shaft by which the rotor is rotatable relative to a stator. The size of the centre-bore is reduced by the first element 7. The conductors 4 are made from compressed and sintered powder and they extend into the short circuit rings to which they are sintered.

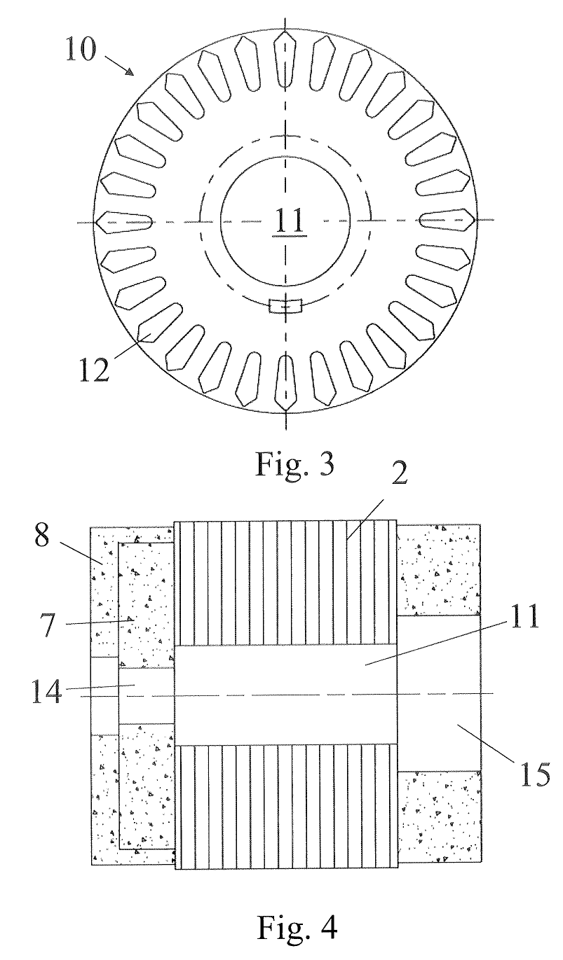

FIG. 3 illustrates the rotor stack seen from above. In this view, the centre-bore 11 and the rotor slots 12 are clearly seen. The rotor slots 12 contain the elongate conductors (shown with numeral 4 in FIGS. 1 and 2) and they are located peripherally around the centre-bore 11 with an essentially equal distance to the centre-bore 11. The centre-bore serves as a shaft bore for a drive shaft.

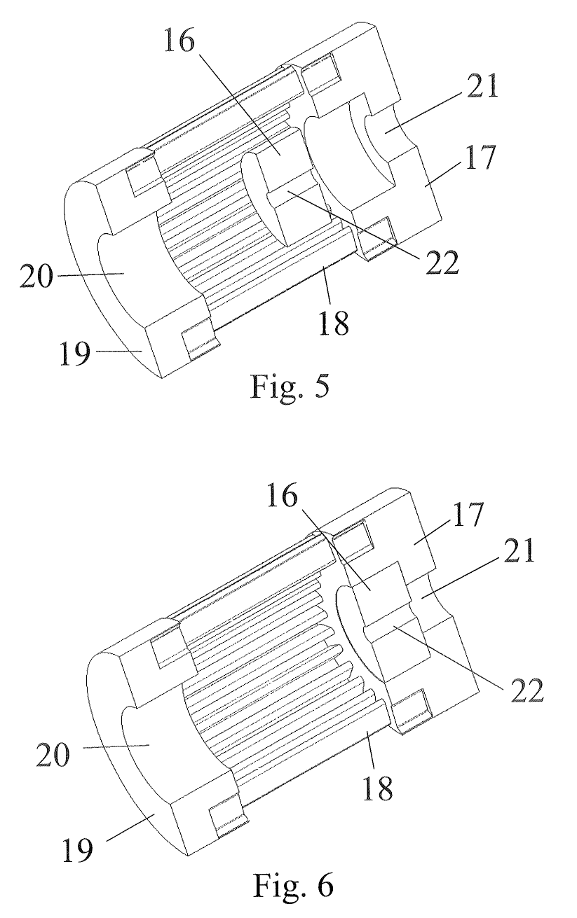

FIG. 4 illustrates an embodiment of the rotor wherein the first element 7 is a ring shaped element with a centre-opening 14 which is coaxially aligned with the centre-bore 11 of the rotor stack and thereby allows a rotor shaft to extend through the rotor, or allows oil, coolant or similar fluids to be pumped along a rotor shaft into the centre-bore and out through the centre-opening. In a similar manner, the short circuit ring in the axial opposite end of the rotor comprises a centre-opening 15 which is also aligned with the centre-bore 11. The first element is fixed between the rotor stack 2 and a second element 8, which second element is sintered onto a peripheral portion of an end face of the rotor stack 2.

The squirrel cage could be made by sintering and the rotor stack could be made with a centre-bore and a number of rotor slots from a plurality of interlocked plates of a magnetically conductive material.

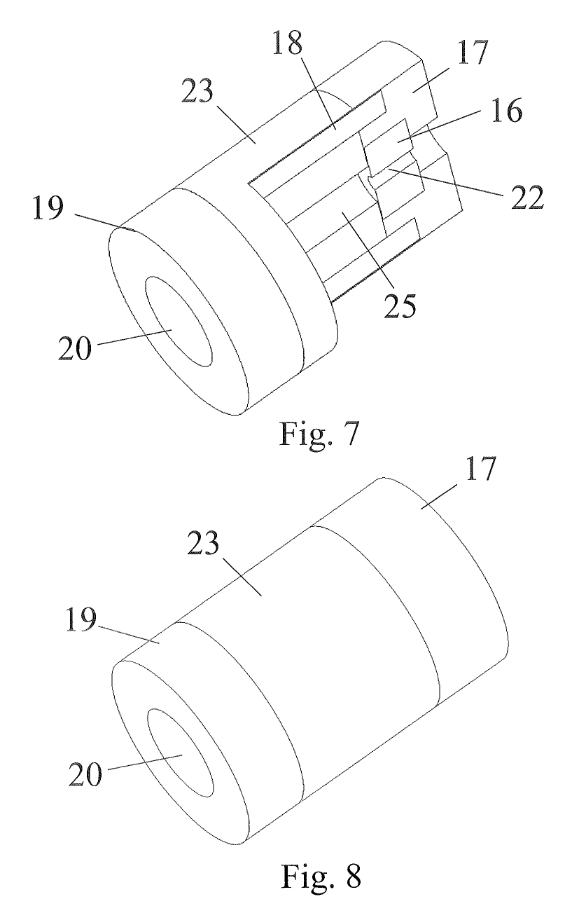

The squirrel cage rotor comprises a number of components which are illustrated in FIGS. 5-8. FIGS. 5-6 illustrate the solid element 16 which is embedded in the sintered body 17, and the conductors 18 which is sintered into the body 17 and 19. In FIG. 5, the solid element 16 is illustrated separate from the sintered body 17. However, this is for illustrative purpose only, since the sintered body 17 is formed directly onto the solid element 16, it would in practice only exist together therewith. The squirrel cage is also illustrated without the rotor stack. Again, this is for illustrative purpose only as the conductors 18 and the bodies 17, 19 forming the short circuit rings are formed directly onto and into the rotor stack. The openings 20, and 21 are formed by protrusions in the mould in which the powder is compressed whereas the opening 22 is formed in the solid element 16 prior to the arrangement of the solid element in the mould. To facilitate manufacturing, the mould may contain a guiding pin which engages the opening 22 and holds the solid element in a fixed position relative to the mould. The mould may also contain a guiding pin which engage the bore shaft or centre-opening in the rotor stack and hold the rotor stack in a fixed position relative to the mould and thereby relative to the solid element 16.

FIG. 7 illustrates a complete rotor including the rotor stack 23 with a section removed for illustrative purposes. The conductors 18 extend through slots in the rotor stack, and the rotor stack forms a centre-opening 24 which can be used as a shaft bore.

FIG. 8 illustrates the assembled rotor. The sintered bodies 17, 19, and the rotor stack 23 form the outer surface of the rotor while the solid element 16 is completely embedded therein.

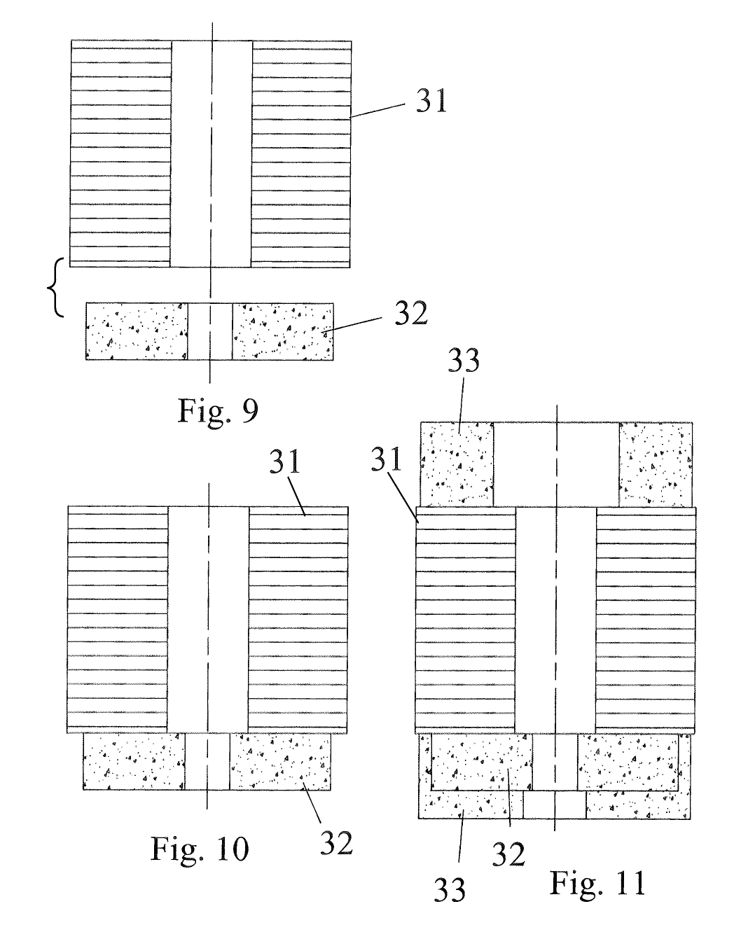

FIGS. 9-11 illustrate a sequence of making a rotor with a centre-opening which has a smaller cross-sectional area than the centre-bore. FIG. 9 illustrates two preformed elements, namely the rotor stack 31 and the first element 32. In FIG. 10, the rotor stack 31 is arranged onto the first element 32 in a mould (not shown). In FIG. 11, a body 33 is formed directly onto the rotor stack 31 and, in one end of the rotor stack 31, also directly onto the first element 32 by sintering. The body extends through slots in the rotor stack 31 and thus forms one single body. The squirrel cage of the rotor is constituted by the body 33 and the first element 32 in combination.

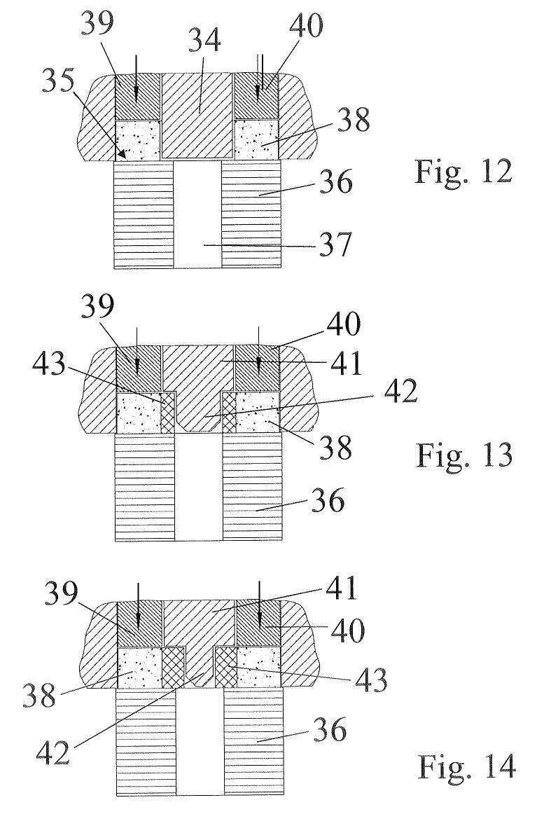

FIGS. 12-14 illustrate a sequence of making one of the short-circuit rings. In a first step, c.f. FIG. 12, an initial core 34 approaches an upper surface 35 of the rotor stack 36 and thereby closes the centre-bore 37. Subsequently, an upper space is filled with powder 38 which is compressed onto the rotor stack 36 by use of the compression pistons 39, 40. In a subsequent step, c.f. FIG. 13, the initial core 34 is replaced by another core 41 (other parts of the mould are not shown). The core 41 comprises a protrusion 42 formed to enter the centre-opening of the first element 43 and thereby function as a guiding pin which forms part of the mould. The first element 43 may e.g. be attached to the core 42 before the core 42 is forwarded down onto the rotor stack 36. In that way, the core 42 is utilized for positioning the first element 43 correctly relative to the rotor stack 36. In a subsequent step, c.f. FIG. 14, the compression pistons once again compress the powder 38 while the core 41 maintains the position of the first element 43 relative to the rotor stack 36.

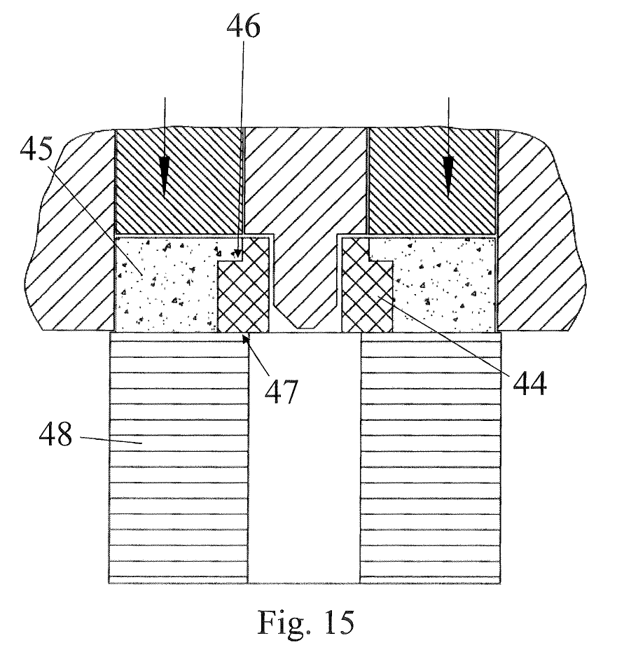

FIG. 15 illustrates an embodiment in which the first element 44 is provided with an irregular interface zone towards the sintered body 45. Due to the step 46, the body 45 locks the position of the first element 44 onto the surface 47 of the rotor stack 48.

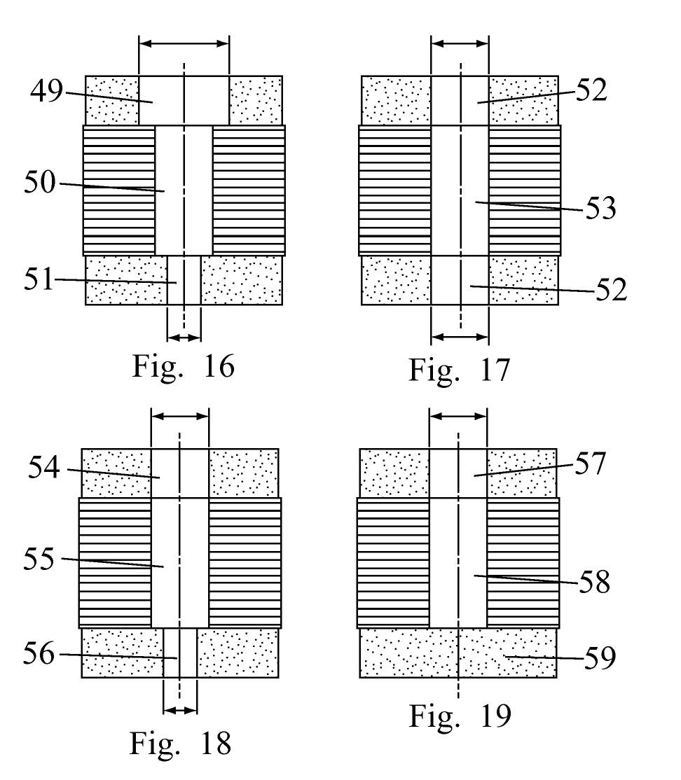

Due to the arrangement of a solid first element in the mould prior to the sintering process, various shapes of the short circuit rings can be made. FIGS. 16-19 illustrate four different embodiments of the rotor according to the invention. In FIG. 16, one of the short-circuit rings has a centre-opening 49 which is larger than the centre-bore 50, and in the other short-circuit ring, a centre-opening 51 which is smaller than the centre bore 50. In FIG. 17, both short-circuit rings have a centre-openings 52 which are of the same size as the centre-bore 53. In FIG. 18, one of the short-circuit rings has a centre-opening 54 which is equal to the centre-bore 55, and in the other short-circuit ring, a centre-opening 56 which is smaller than the centre bore 55. In FIG. 19, one of the short-circuit rings has a centre-opening 57 which equal to the centre-bore 58, and the other short-circuit ring 59 has no centre-opening at all.

It should be understood that the invention is not limited to the disclosed details of the specific embodiments, and further that features disclosed relative to one embodiment may be combined also with other of the disclosed embodiments.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A method of making a squirrel cage rotor for an electrical motor, the method comprising the steps of:
providing a mould for sintering,
providing in the mould a first portion of a powder adapted for sintering,
providing a solid element in the mould,
providing a rotor stack with axially extending rotor slots in the mould,
filling the rotor slots with powder,
filling an upper space above the rotor stack with the powder, and
sintering the powder to provide short circuit rings on axially opposite sides of the rotor stack.

2. The method according to claim 1, wherein the solid element is a preformed ring shaped element.

3. The method according to claim 1 wherein the solid element is positioned relative to the rotor stack by use of a guiding pin which forms part of the mould.

4. The method according to claim 1, further comprising the steps of compressing the powder between at least two of the steps.

5. The method according to claim 1, further comprising the steps of sintering the powder between at least two of the steps.

6. The method according to claim 1, further comprising the step of providing a solid element in the upper space prior to the filling of the space with powder.

7. The method according to claim 1, wherein at least one of the solid elements is preformed by compression of powder.

8. A squirrel cage rotor for an electrical motor, the rotor comprising a rotor stack of a magnetically conductive material and a squirrel cage of an electrically conductive material, the squirrel cage forming elongate conductors extending through the rotor stack and terminating in short circuit rings on axially opposite sides of the rotor stack, at least one of the short circuit rings comprising a first element which is located between the rotor stack and a second element which is sintered onto at least one of the first element and the rotor stack.

9. The rotor according to claim 8, wherein the second element comprises a rim portion which peripherally encircles the first element and which is sintered onto the rotor stack.

10. The rotor according to claim 8, wherein the first element is embedded in the second element.

11. The rotor according to claim 8, wherein the first element is ring shaped with a centre-opening.

12. The rotor according to claim 11, wherein the rotor stack comprises a centre-bore for a rotor shaft, the centre-bore being co-axial with the centre-opening.

13. The rotor according to claim 12, wherein the centre-opening has a cross-sectional area being at most equal to a cross-sectional area of the centre-bore.

14. The rotor according to claim 11, wherein the centre-opening is circular.

15. The rotor according to claim 8, wherein at least one of the first element and the second element is made from a material which contains aluminium.

16. The rotor according to claim 8, wherein at least one of the first element and the second element is made from a material which contains cobber.

17. The rotor according to claim 8, wherein the first and second elements are made from the same material.

18. The rotor according to claim 8, wherein the conductors and the second element are formed in one part by sintering.

19. The rotor according to claim 8, wherein the conductors are sintered onto the first element.

20. The rotor according to claim 8, wherein the first element is joined to the second element in an irregular interface zone.

21. The rotor according to claim 8, wherein the second element forms an axial end face of the rotor.

22. The rotor according to claim 8, wherein electrically conductive material is isolated from the magnetically conductive material.

23. The rotor according to claim 22, wherein the rotor stack is coated to increase an iron-oxide layer on a surface thereof to isolate the electrically conductive material from the magnetically conductive material.
